(19) United States
(12) Patent Application Publication
(10) Pub. No.: US 2003/0152743 A1
(43) Pub. Date: Aug. 14, 2003

(54) Base cloth for tufted carpet and tufted carpet using the same

(76) Inventors: Atsushi Matsunaga, Aichi (JP); Tomoko Watanabe, Aichi (JP); Mamiko Matsunaga, Aichi (JP); Yukitoku Watanabe, Aichi (JP)

Correspondence Address: Fildes & Outland, P.C., Suite 2, 20916 Mack Avenue, Grosse Pointe Woods, MI, 48236, US

(21) Appl. No.: 10/371,039

(22) Filed: Feb. 19, 2003

Related U.S. Application Data
(62) Division of application No. 09/720,629, filed on Feb. 28, 2001.
Application No. 09/720,629 is a 371 of international application No. PCT/JP00/02685, filed on Apr. 25, 2000.

(30) Foreign Application Priority Data
Apr. 26, 1999 (JP) 11-117884

(51) Int. Cl. D05C 17/02; B32B 33/00

(52) U.S. Cl. 428/97; 428/95; 428/92

(57) ABSTRACT

Base cloth for tufted carpet and tufted carpet using the same. The base cloth is constituted by nonwoven fabric made of filament formed of poly lactic acid based polymer. The filament has round cross-section and birefringence of 12×10⁻³ to 30×10⁻³ and crystallization degree of 15 to 25 percent by weight. The nonwoven fabric made of filament has heat shrinkage of 1 percent or less at 120° C. in 3 minutes both in a machine direction (MD) and a cross direction thereto (CD). If the cross-section of the filament is not round, the filament has crystallization degree of 15 to 25 percent by weight and heat shrinkage of 1 percent or less at 120° C. in 3 minutes both in MD and CD.

### Cross Reference to Related Application

This application is a division of application No. 09/720,629 filed Feb. 28, 2001, which is a 371 of PCT/JP00/02685 filed Apr. 25, 2000 which claims priority of Japan 11/117884 filed Apr. 26, 1999.

### FIELD OF THE INVENTION

The present invention relates to a base cloth for tufted carpet comprised of nonwoven fabric made of accumulated filaments and the carpet using the same.

### BACKGROUND OF THE INVENTION

Nonwoven fabric made of a large number of accumulated filaments is used for base cloth for tufted carpet. Known base cloth for tufted carpet is used as a supporting and backing medium wherein pile yarn is embedded and tufted. The base cloth is mainly made of nonwoven fabric of polyethylene-terephthalate.

When it becomes unnecessary the tufted carpet makes a bulky waste and is difficult to be disposed. Because the heat quantity generated in connection with the incineration is large when the carpet is to be disposed by incineration, the service life of the incinerator may be shortened and toxic gas or black smoke may be generated. And when the carpet is disposed by landfilling method there may occur a detrimental effect on environment because of its non-biodegradable nature. When polyvinyl chloride is used as backing layers for the carpet, dioxin may be generated when the backing layers are incinerated.

In recent years, recycling of synthetic fiber begins to draw attention. However, in a carpet, pile yarn is implanted onto the base cloth, and backing layers are used in the side opposite to the pile side of this base cloth in order to prevent loss of pile yarn. There is also a carpet of structure wherein backing layers are covered-with second base cloth. Because these materials are not made of the same raw materials, the carpet is difficult to be recycled.

### SUMMARY OF THE INVENTION

It is an object of the present invention to solve above described problems, and to provide abase cloth for a tufted carpet causing no environmental problem even in the case of becoming unnecessary and to provide a tufted carpet using the same.

To achieve this object the base cloth for the tufted carpet according to the present invention is constituted by nonwoven fabric made of filament of poly lactic acid based polymer. The filament has a round cross-section, birefringence of 12×10⁻³ to 30×10⁻³ and crystallization degree of 15 to 25 percent by weight. The base cloth for the above described tufted carpet has heat shrinkage of less than 1 percent at 120° C. in three minutes in both directions of machine direction (MD) and cross direction (CD).

In addition, the base cloth for the tufted carpet according to the present invention is constituted by nonwoven fabric made of filament of poly lactic acid based polymer. The above described filament has a non-round cross-section and crystallization degree of 15 to 25 percent by weight. The above described base cloth for the tufted carpet has heat shrinkage of less than 1 percent at 120° C. in three minutes in both direction of MD and CD.

The tufted carpet according to the present invention includes the above described base cloth. The carpet preferably has a configuration wherein the pile yarn made of poly lactic acid based polymer is tufted on the base cloth. Preferably backing layers made of biodegradable material is provided in the side opposite to the tufted pile side of this base cloth.

According to the present invention, because the base cloth used for the tufted carpet is constituted by a nonwoven fabric made of filament of poly lactic acid based polymer, the base cloth has required biodegradability, and, as a result, does not cause environmental problems in nature. Poly lactic acid apparently, due to its chemical structure, has higher stiffness than polyester. By this reason, when this base cloth is tufted, it is difficult that filaments of the base cloth are stuck directly by tufting needles and as a result, the filament easily slips off a needle. Therefore a damage given to fiber decreases, and mechanical strength of the tufted base cloth is maintained. When the final product is for example a tile carpet, it maintains stiffness, and may have an improvement in workability during the installation on the floor. When the above described filament has crystallization degree of 15 to 25 percent by weight and round cross-section, because this filament has birefringence of 12×10⁻³ to 30×10⁻³, it is apparent this filament has moderate stiffness and simultaneously the polymer constituting the filament is oriented enough. Accordingly the final product with superior dimensional stability and mechanical property is provided. The base cloth of the present invention is superior in thermal stability. Therefore the base cloth has durability to heat, without shrinking, given in the process where it is laminated or coated by the backing layer during the backing process and where it is heated in the oven during backing layer hardening process after the layer is attached. As a result, a carpet with excellent dimensional stability is provided.

### BRIEF DESCRIPTION OF THE DRAWINGS

FIG. 1 is a schematic view showing a cross-section of multilobed type conjugate filament constituting the base cloth of the present invention; and

FIG. 2 is a schematic view showing a cross-section of other example of multilobed type conjugate filament constituting the base cloth of the present invention.

### DISCLOSURE OF THE INVENTION

The base cloth for the tufted carpet of the present invention is constituted by nonwoven fabric made of filament formed by poly lactic acid based polymer. The poly lactic acid based polymer is superior in biodegradability and spinnability compared with other polymers. In addition, it has higher stiffness compared with polyester or other filament as is apparent considering the chemical structure of poly lactic acid. On this account when this base cloth is tufted it is difficult that tufting needle directly sticks filaments of the base cloth and as a result, the filament can slip off the needle. Therefore the damage on the filament decreases, and mechanical strength of the tufted base cloth is maintained. When a tile carpet, for example, is produced as a final product, the tile carpet with enough stiffness shows an improved workability when it is laid on the floor.

As poly lactic acid based polymer, the polymer with melting point of equal to or higher than 100° C. selected from the following group is preferably used. The group includes poly (D-lactic acid), poly (L-lactic acid), copolymer of D-lactic acid and L-lactic acid, copolymer of D-lactic acid and hydroxycarboxylic acid, copolymer of L-lactic acid and hydroxydarboxylic acid, copolymer of D-lactic acid, L-lactic acid and hydroxycarboxylic acid. A blend of the polymers with melting point equal to or higher than 100° C. is also preferable.

Poly (L-lactic acid) and poly (D-lactic acid) which are homopolymer of poly lactic acid have melting point of about 180° C. When the above described copolymer is used as poly lactic acid based polymer, it is preferable that the copolymerizing ratio of monomers is determined to give the melting point of the resulting copolymer of higher than 120° C. It is desirable for this purpose that the copolymerization mole ratio of (D-lactic acid)/(L-lactic acid) is in the range of 100/0 to 90/10 or 10/90 to 0/100.

As hydroxycarboxylic acid in the case of copolymer of lactic acid and hydroxycarboxylic acid, the hydroxycarboxylic acid selected from the group of glycolic acid, hydroxy butyric acid, hydroxy valeric acid, hydroxy pentanic acid, hydroxy caproic acid, hydroxy heptanic acid and hydroxy octanoic acid are used. It is particularly preferable to use hydroxy caproic acid or glycolic acid in terms of cost.

In the present invention, the filament obtained from the poly lactic acid based polymer, when it has round cross-section, necessarily has birefringence of 12×10⁻³ to 30×10⁻³ and crystallization degree of 15 to 25 percent by weight. “Round” here means that cross-section is round enough where birefringence of the fiber can be measured.

Birefringence represents the degree of molecular orientation. If the birefringence is lower than 12×10⁻³ and the crystallization degree is lower than 15 percent by weight, residual elongation of this filament increases because of insufficient molecular orientation and excessively low crystalinity of the poly lactic acid consisting the filament. As a result, the provided nonwoven fabric namely base cloth shows a tendency of having insufficient dimensional stability and mechanical property. In addition, because the base cloth has poor heat stability, it cannot have durability to heat given during the backing process in the after-mentioned carpet manufacturing process, causing the base cloth shrinking, and as a result, the carpet with excellent dimensional stability cannot be obtained. Therefore the base cloth without above described properties is not suitable for the base cloth of the tufted carpet.

On the other hand, if the birefringence is higher than 30×10⁻³ and the crystallization degree is higher than 25 percent by weight, the dimensional stability and the mechanical property of the nonwoven fabric become excellent, but the stiffness of the filament becomes too high resulting in poor flexibility. Therefore, the filament receives heavier damage by the tufting needle during the tufting process and the tensile strength of the base cloth after tufting decreases. When the tufted carpet is necessarily processed by thermal molding for example, it gives poor moldability.

When cross-sectional configuration of the filament is not round it is not possible to measure the birefringence of the filament. In such case the limitation for only crystallization degree is valid. The range of the crystallization degree is 15 to 25 percent by weight, the same as the above. What this range means is the same as the above.

In the present invention, birefringence is measured using polarizing microscope with Berek compensator and tri-cresylphosphate as immersion liquid.

The crystallization degree is measured by the following methods. The filament for measuring is ground into powder and packed into an Aluminium sampling case (20×18×0.5 mm), thereby a target sample is formed. The vertically held sample is irradiated by Cu-K α-ray from a direction perpendicular to the sample using RAD-rB type of X-ray generatorby Rigaku Corporation. As photoreceiver curved graphite monochrometor is used. Scanning is performed in the range of 2θ=5 to 125 degree and the crystallization degree is obtained in the form of percent by weight by Ruland method.

It is necessary that the base cloth of the present invention has heat shrinkage of less than 1 percent. The heat shrinkage here is the one in both MD and CD, and is measured at 120° C. for three minutes. The reason is described below. Tufted carpet is manufactured, as is described later, by tufting pile yarn to the base cloth and by attaching backing layer to fix the pile yarn. When the backing layer is attached, a backing material heated and melted is usually extruded and laminated to the base cloth. After the lamination process the laminated carpet is introduced into oven to dry and harden the material. If the heat shrinkage is more than 1 percent, the base cloth cannot have durability to heat given in the backing process, giving shrinking to the base cloth, and as a result, a carpet with excellent dimensional stability cannot be obtained. In the case that the carpet is treated in the after-dyeing process the carpet is treated with steam under temperature over 100° C., and then the base cloth shrinks resulting in the carpet with poor dimensional stability.

The structure of the filament in the nonwoven fabric providing the base cloth of the present invention may be in the form of monocomponent structure comprised of poly lactic acid based homopolymer or may be in the form of multicomponent structure comprised of plurality of polymers. As the multicomponent structure, a sheath-core type, side-by-side type, island-sea type or multilobed type structure may be preferable. In the type of monocomponent structure, sheath-core, side-by-side or island-sea, both cases of round and non-round cross-sections are possible. On the contrary, in the case of multilobed type, only the non-round cross-section is possible.

Because the filament of the monocomponent structure does not contain polymer with low melting point giving binder material, it can provide base cloth with low heat shrinkage.

The filament of multicomponent structure is obtained from a combination of polymer with low melting point and polymer with high melting point. The polymer with high melting point preferably has melting point of 20° C. higher than the one of the polymer with low melting point. And a portion of the polymer with low melting point is preferably located on the surface of the filament. When these filaments of multicomponent structure is used, the polymer with low melting point is softened or melted in the step of heat treatment to manufacture the nonwoven fabric, giving thermal bonding between the filaments. On the contrary, the polymer with high melting point maintains its filament structure without receiving any effect by heating. As a result, the nonwoven fabric made of the filament maintains mechanical property such as dimensional stability, tensile strength and superior flexibility. Furthermore, the friction resistance of needle penetrating the thermal bonding area decreases and as a result, easy tufting motion of needle is obtained.

The weight ratio of the polymers with high melting point and low melting point in the filament of multicomponent structure is preferably (polymer with high melting point)/(polymer with low melting point)=90/10 to 10/90(by weight). If this weight ratio of the polymer with high melting point is less than 10 percent, it means the portion of the polymer with low melting point is excessive and in some case, the melted filament sticked to the roll used in the process of bonding with heat and pressure to manufacture the nonwoven fabric under a certain temperature. The processability, therefore, is damaged seriously. When the ratio of the polymer with high melting point is less than 10 percent, the portion of the polymer with low melting point in the area bonded with heat and pressure becomes excessive, and as a result, the mobility of the filament is limited by harder bonding between the filaments. Then it becomes difficult for the filament to follow needle motion and the filament is broken. And then in some case the base cloth may not obtain the property requested as the base cloth for carpet because of inferior mechanical strength. On the contrary, if the ratio of the polymer with high melting point is more than 90 percent, it means the portion of the polymer with low melting point is insufficient, and the thermal bonding forming the nonwoven fabric cannot be enough. Therefore, the provided mechanical property of the nonwoven fabric decreases and the advantage using the polymer with low melting point is not performed. For this reason, the ratio of (polymer with high melting point)/(polymer with low melting point) is more preferably 70/30 to 30/70 by weight.

It is preferable for the polymer with low melting point to have compatibility with the polymer with high melting point. As the combination of the both polymers, for example, a combination between copolymers of different mol ratio of D-lactic acid and L-lactic acid and a combination between poly lactic acid as polymer with high melting point and copolymer of lactic acid and hydroxycarboxylic acid as polymer with low melting point are preferable.

The above described poly lactic acid based polymer may contain any additives such as flatting agent, pigment, flame repellent, antifoaming agent, antistatic agent, antioxidant and UV absorbant, so far as the object of the present invention is not damaged.

When the sheath-core type multicomponent structure is used, the polymer with high melting point is located in the core, and the polymer with low melting point which makes the binder element to manufacture the nonwoven fabric by thermal processing is located in the sheath. When this sheath-core structure is adopted, only the sheath component will be soften or melted, bonding the filaments each other during the thermal bonding process for manufacturing the nonwoven fabric. In this case, the core maintains a form of filament. Therefore, even if the tufting needle touches the bonding between the sheath filaments and breaks the bonding during the tufting process, the strength of the base cloth will decrease only a little. In the case that the tufting needle touches the filament, the sheath in the surface of the filament is damaged but the core, in the inside of the filament, is not damaged. Thus, the filament with multicomponent structure is less damaged than the filament with monocomponent structure and as a result, the decrease in strength of the base cloth is smaller.

Multilobed type filament with multicomponent structure will be described in detail in the following paragraph.

This multilobed type filament has a cross-section of a multilobed shape where the polymer with high melting point is located in the core and the polymer with low melting point is located in more than 2 lobe parts. More than 2 lobe parts form a plurality of projecting part on the surface of the filament. The polymer with low melting point, as bonding element, has wider surface area because of the above described construction. Therefore, the nonwoven fabric can have larger number of bonded area between the filaments of the nonwoven fabric. Accordingly when the nonwoven fabric is manufactured by bonding with heat and pressure, enough bonding strength can be obtained without processed under excessive pressure. As a result, the base cloth with high tensile strength and elongation can be obtained. Because the polymer with low melting point projects on the surface of the filament, the polymer softened or melted can flow into the void between the filaments during the bonding with heat and pressure. As a result, the void is filled with the polymer. This means that increase of the strength of the nonwoven fabric is obtained not only in length and width direction but in thickness direction. By increasing the strength in thickness direction of the nonwoven fabric configuring the base cloth, the base cloth for the tufted carpet without peeling off between layers during tufting process can be obtained.

The degree of the projection or the shape of the lobe part (projecting part) constituted by the polymer with low melting point can be changed by selecting the weight ratio of (polymer with high melting point)/(polymer with low melting point) or the ratio of melt flow viscosity between the component polymers.

It is necessary that the number of the lobe part of the multilobed type conjugate filament is more than 2 and preferably 3 to 10 and more preferably 3 to 6. If the number of the lobe part is excessive, the degree of projection of the lobe part (the projecting part) becomes small and as a result, the lobe part cannot exert its effectiveness.

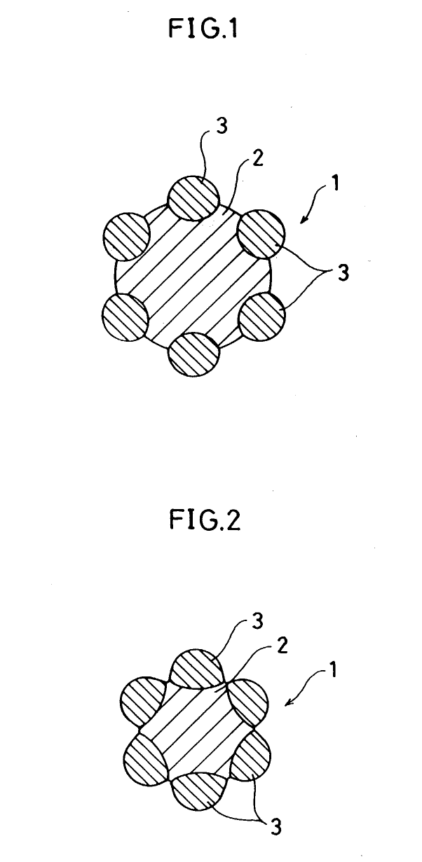

FIG. 1 is a schematic view showing a cross-section of an example of multilobed type filament constituting the base cloth of the present invention. This multicomponent filament 1 has the polymer with high melting point 2 in its core and has two or more lobe parts having the polymer with low melting point 3. The polymer with high melting point 2 and the polymer with low melting point 3 each appear on the surface of the filament 1 in turn. In this cross-section structure, the construction can be performed, wherein the polymer with high melting point 2, which is considerably higher melting point than temperature of bonding with heat and pressure, partially appears on the surface of the filament 1. By using this structure the advantage is obtained, wherein even if the temperature in the bonding with heat and pressure is raised up to about the melting point of the polymer with low melting point 3, the surface of the thermal pressing roll is not covered with softened or melted polymer.

FIG. 2 is a schematic view showing a cross-section of other example of multilobed type conjugate filament constituting the base cloth of the present invention. In this example, in FIG. 2, the projecting lobe part is formed in the shape where all the polymer with high melting point 2 is surrounded by the polymer with low melting point 3.

Nonwoven fabric using filament is manufactured by the known method, for example, spunbond process. In this spunbond process, filament is taken up according to melt spinning method and the filament is then accumulated by being piled up onto moving accumulating conveyer. In detail, the poly lactic acid based polymer is melt spun from standard spinning nozzle. After the filament spun is cooled, it is drawn and attenuated using an air sucker. After the filament is opened by known method, it is accumulated as web on the moving accumulating device. The take up speed in drawing by an air sucker is preferably, for example, 3000 to 6000 m/minute. In the case of lower than 3000 m/minute, the molecular orientation of the poly lactic acid forming filament is not obtained enough, therefore the tensile strength of the filament becomes inferior. And as a result, the mechanical strength of the nonwoven fabric using the filament becomes poor. On the other hand, in the case of higher than 6000 m/minute, the spinnability in melt spinning will be inferior. If the filament is obtained which does not have enough orientation of the poly lactic acid (undrawn filament) by the speed of less than 3000 m/minute, the filament may be drawn or drawn and heated after spinning. Thus, the filament of poly lactic acid (undrawn) may be oriented enough and as a result, the nonwoven fabric with birefringence and crystallization degree according to the present invention is obtained.

The example of the filament nonwoven fabric is selected from a group of the followings, that is, the filament nonwoven fabric of monocomponent structure, the nonwoven fabric of multicomponent structure, the nonwoven fabric blends of monocomponent filament and multicomponent filament, and the nonwoven fabric blends of the monocomponent filament and the monocomponent filament consisting of different polymer from that of the other.

Fineness of filament constituting the nonwoven fabric is preferably 2 to 14 dtex. If the fineness is less than 2 dtex, the tensile strength of the nonwoven fabric becomes low. When this nonwoven fabric needs to be processed by needle punching or by pile tufting, the filaments may easily be cut, and even if it is blended with coarser fineness filament, the tufted carpet obtained has a tendency to have inferior strength. On the other hand with filament of more than 14 dtex, the number of filaments constituting the nonwoven fabric decreases in unit weight. This means less number of bonded area between the filaments and sometimes gives inferior mechanical property of the nonwoven fabric obtained. In some cases, the bonded area between the filaments in the nonwoven fabric is easily broken. Therefore, the whole nonwoven fabric becomes rough and the flexibility of the carpet obtained may be damaged. As a result, the properties requested cannot be obtained.

The apparent density of the base cloth of the present invention is preferably equal to or less than 0.4 g/cm³. When the apparent density is more than 0.4 g/cm³, the base cloth becomes extremely coarse and the tufting needle is interrupted to go through in the base cloth by increased friction resistance. The minimum of the apparent density is preferably about 0.08 g/cm³ considering the weight and thickness of the base cloth. When the apparent density becomes too small, the thickness of the base cloth extremely increases in order to obtain enough weight supporting the pile yarn. The thick base cloth requires more pile yarn to obtain requested pile height and will give heavier carpet or higher cost. The apparent density is more preferably 0.1 to 0.35 g/cm³.

The base cloth of the present invention is preferably needle-punched nonwoven fabric where the filaments are entangled with each other by needle punching. In the needle-punched nonwoven fabric, because the filaments constituting nonwoven fabric are entangled with each other not only two-dimensionally but in thickness direction, the peeling between layers in the base cloth will not occur during the tufting process and as a result, dimensional stability is sufficiently kept.

The preferable needle punching density, depending on the type of needle used or on the needling depth, is generally 20 to 100 punches/cm². If the density is less than 20 punches/cm², the filaments are insufficiently entangled with each other and needle punching effect is not obtained. On the other hand, if the density exceeds 100 punches/cm², the degree of entangle between the filaments becomes stronger but the filaments are deeply damaged by the needle. As a result, the tensile strength of the filaments intensely decreases, giving poor mechanical strength of the base cloth.

Some bonded part, in which the filaments are thermally bonded with each other, is preferably located in the needle punched or not punched base cloth in order to increase the stress in elongation and the tensile strength. Thermal bonding between the filaments is performed by the method described hereinafter, that is, the method wherein the base cloth is introduced to a heat embossing machine using a couple of embossing rolls or a couple of embossing roll and flat roll giving thermal bonding of the filaments at the projecting point of the embossing roll, the method wherein the base cloth is introduced to a couple of flat roll giving thermal bonding to only the filaments on the surface of the base cloth, and the method wherein heated air is flown to the base cloth giving thermal bonding at the intersection point. In the above described method the method wherein the cloth is introduced between the two rolls can control the thickness of the base cloth.

The filaments are bonded partially with heat and pressure using embossing rolls. In this partial bonding with heat and pressure, heat boding temperature and heat bonded area ratio are important factors.

The temperature for bonding with heat and pressure, that is roll temperature, should be set from (Tm-50) ° C. to (Tm-5) ° C. where Tm is the melting point of the polymer with low melting point. If the bonding temperature of the rolls is set to be lower than (Tm-50) ° C., the polymer with low melting point is melted insufficiently causing low bonding strength between the filaments. When the nonwoven fabric is used as the tufted carpet base cloth, the mechanical property of the base cloth becomes poor and at the same time the bonded area is easily broken and the layers in the base cloth peels off each other easily by the shock of tufting action of needle. And as a result, a base cloth with inferior property is obtained. On the other hand, if the temperature of the rolls is set to be higher than (Tm-5) ° C., the melted polymer with low melting point sticks to an apparatus for bonding with heat and pressure, causing the resulting operability and processability to be extremely poor. At the same time, the polymer with high melting point is also melted or softened with the excessively high temperature of the roll, and the base cloth obtained becomes extremely stiff and coarse. Therefore, the friction resistance is increased when the tufting needle penetrates the base cloth.

The bonded area ratio should be 4 to 40 percent. Here the bonded area ratio means the ratio of the bonded area to the whole area of the nonwoven fabric. If the ratio is less than 4 percent, the bonded area is too small in the whole area of the nonwoven fabric. In this case, the base cloth cannot obtain enough strength against tensile stress which works to the cloth during the following process such as tufting, dyeing and backing. On the other hand, if the ratio is higher than 40 percent, the mobility of the filament between the bonded areas is decreased, and it becomes difficult for the filament to follow needle motion and the filament is broken. Therefore, the tensile strength of the base cloth in the tufted carpet is decreased.

The position in the web, which touches the projecting point of the embossing roll during the bonding with heat and pressure, makes the bonding area. Accordingly, the embossing roll which has 4 to 40 percent of projecting area to the whole surface area of the roll is used. The shape of the top projecting point is equal to the shape of the bonded are of the nonwoven fabric. The shape is not especially limited, and it is possible to use shape of round, elliptical, rhombus, triangle, T shape, oxford frame, rectangle, square and so forth. The area of the top projecting point is preferably approximately 0.1 to 1.0 mm².

It is preferable to use linear pressure of approximately 100 to 900 N/cm in the bonding with heat and pressure.

In the base cloth of the present invention, to improve the stress on stretching and tensile strength, it is preferable that a binder resin is attached to the base cloth in order to adhere the contact point between the filaments by the binder resin. The amount of the applied binder resin (solid deposit amount) is preferably 2 to 15 percent by weight of the total weight of the base close for the tufted carpet. If the deposit amount of the resin is less than 2 percent by weight, the effect of using binder resin is not performed. On the other hand, if the deposit amount is more than 15 percent by weight, the amount of the resin between the filaments becomes excessive. Therefore, the mobility of the filament is limited during the tufting process and the tufting needle cannot easily penetrate the base cloth, and the flexibility of the tufted carpet has a tendency of becoming poor. As the binder resin, the above described poly lactic acid based polymer for the base cloth is preferably used. Or, poly vinyl alcohol, polysaccharides that is natural polymer such as starch, proteins and chitosans may be used. Besides, monomers such as methyl acrylate, ehtyl acrylate, butyl acrylate, methyl methacrylate, ethyl methacrylate, butyl methacrylate, acrylonitrile and styrene are used in the range that biodegradability is not damaged.

The total weight of the base close for the tufted carpet of the present invention is set as desired and preferably is 50 to 150 g/m² by weight in general. If the weight is less than 50 g/m², the mechanical strength of the base cloth decreases. Because the total amount of the filament in the base cloth is small, the retention power for the tufting yarn to the base cloth is not enough, causing falling off of tufting yarn during the tufting process. On the other hand, if the weight is more than 150 g/m², the total amount of the filament in the base cloth is excessive and therefore evenness in height of the pile yarn cannot be obtained or tufting stitch becomes uneven. At the same time, the carpet obtained has excessive performance and is not economical.

In the tufted carpet of the present invention, a biodegradable tufting yarn is implanted by tufting method on the basecloth. The biodegradable fiber configuring the tufting yarn is selected from the following yarn, that is, yarn made of poly lactic acid based polymer used in the base cloth mentioned above, yarn made of aliphatic polyester, natural fiber and regenerated fiber. Cotton wool and linen are suitable as natural fiber, and rayon, acetate and rayon obtained by the solvent spinning method are suitable as regenerated fiber. Cotton, wool and regenerated fiber are preferably used to obtain excellent water absorbing property and touch. From the standpoint of recycling, the same type of material used for the base cloth that is poly lactic acid based polymer is preferably used and more preferably bulky textured yarn is used for tufting yarn.

In the tufted carpet of the present invention, backing layer is attached in order to fasten the pile yarn and to reinforce the carpet in the back side of the tufted pile yarn. As the backing material, the known bitumen, ethylene vinyl acetate resin, polyurethane resin are preferably used. From the standpoint of biodegradability, poly lactic acid based polymer used in the above described base cloth and aliphatic polyester are preferably used. As the method of attaching the backing layer, for example, the following method are used, that is, the coating or impregnating method wherein the base cloth is coated or impregnated by the melted resin, the foam method wherein resin solution foam is coated in the back face of the base cloth and then dried, and the powder method wherein the power resin is melted and simultaneously coated on the surface of the nonwoven fabric.

### EXAMPLES

The examples of the present invention will be described below in detail. The present invention, however, is not limited by the examples.

The measuring methods of each properties in the examples are as follows.

(1) Melting point (° C.): The temperature is determined to be melting point which gives the peak in the melting endothermic curve obtained where 5 mg of sample is measured at temperature rising rate of 20° C./minute using DSC-7 type of differential scanning calorimeter made by Perkin-Elmer.

(2) Melt Flow Rate of poly lactic acid (g/10minutes): The extruded amount of the melted poly lactic acid is determined to be Melt Flow Rate (hereinafter “MFR”) which is measured under the condition of load weight of 21.17N and at 210° C. according to the method described in ASTM D1238.

(3) MFR of polypropylene (g/10 minutes): The extruded amount of the melted polypropylene is determined to be MFR which is measured under the condition of load weight of 21.17N and at 230 ° C. according to the method described in ASTM D1238.

(4) Spinnability: The extruded filaments are drawn by air sucker and graded into three groups as follows.

Good: filament breakage zero/spinning end-hour

Marginal: filament breakage less than 3 times/spinning end.hour

Bad: filament breakage more than 3 times/spinning end-hour

(5) Fineness (dtex): The diameter of the 50 filaments in the web is measured using microscope and the mean result value, adjusted by density, is determined to be fineness (dtex).

(6) Weight (g/m²): Ten pieces having a length of 10 cm and width of 10 cm, cut from the sample in standard conditions, are weighed (g) after reached moisture equilibrium. The mean value is converted to a value per unit area giving the weight (g/m²).

(7) Crystallization degree (percent by weight): The measuring sample of nonwoven fabric of filament is ground into powder, packed into an aluminum sampling case (10×18×0.5 mm). The sample case is held vertically. The sample is irradiated by Cu-K α-ray from a direction perpendicular to the sample using the RAD-rB type X-ray generatormade by Rigaku Corporation. As photo receiver, a curved graphite monochrometor is used. Scanning is performed in the range of 2θ=5 through 125 degree and the crystallization degree is obtained in the form of percent by weight by the Ruland method.

(8) Birefringence (×10⁻³): Birefringence is measured using a polarizing microscope with Berek compensator and tri-cresylphosphate as immersion liquid.

(9) NSM strength (N/5 cm width): The sample with 5 cm of width and 30 cm of length is measured under the condition of the grip interval of 20 cm according to the strip method described in JIS L1096 using constant rate of extension testing machine (Tensilon RTM-500, Toyo Baldwin Co.,). The mean value obtained from 10 samples is calculated and the value converted by weight 100 g/m² is determined to be NSM strength. Both NSM strength in the MD (machine direction) and CD (cross direction) are measured respectively.

(10) Heat shrinkage of the base cloth (percent): The length of 5 samples with 20 cm×20 cm is measured in 3 positions in the MD and CD, respectively. The mean length in the MD is determined to be LM₀ and that in the CD is determined to be LC₀. The samples are then heated under the condition of constant length in the heat air dryer at 120° C. for 3 minutes. The length of the samples after the heat treatment is measured in the same above described method in 3 positions in the MD and CD, respectively. The mean value of the length in the MD is determined to be LM, and that in the CD is determined to be LC₁. The heat shrinkage of the base cloth is calculated in the following equation.

Heat shrinkage in the MD (%)=(LM₀−LM₁)/LM₀

Heat shrinkage in the CD (%)=(LC₀−LC₁)/LC₀

(11) Stiffness of the base cloth (cN·cm/cm²): Measurement is performed according to the method of measuring compressibility of the KES-FB system. In detail 5 pieces of 20 cm×20 cm samples are prepared for measuring. The sample is placed on the sample table after the maximum load is set. The sample then is compressed by the compression plate at a speed of 1 mm/50 seconds. The compression stiffness obtained is determined to be the stiffness of the base cloth.

(12) Strength retention after tufted: The base cloth is tufted by pile yarn. The NSM strength (N/5 cm) of the tufted base cloth is measured according to the above described method. The strength retention is calculated by the following equation.

Strength retention (percent)=((NSM strength of the base cloth after tufted)/(NSM strength of the base cloth before tufted))×100

The strength retention is graded into three groups as follows.

Good: The strength retention is more than 80%.

Marginal: The strength retention is equal to 55% or more and less than 80%.

Bad: The strength retention is less than 55%.

(13) Backing processability: It is graded into three groups as follows.

Good: There are no voids between the piled fabric and the backing layer and backing is uniformly performed.

Marginal: There are a few voids between the piled fabric and the backing layer.

Bad: There are voids between the piled fabric and the backing layer

(14) Durability against wearing out: The pile on the fabric is pressed by a round plain faced pressing plate with 180 cm² of area under the pressure of 40 kPa for 5 seconds. This pressing is repeated 500 times and the degree of falling down of pile is determined as durability against wearing out.

Good: There is no change in appearance.

Bad: The pile falls down.

(15) Biodegradability: The measurement is performed according to ISO/14855.

Good: The biodegradability is more than 70%.

Bad: The biodegradability is less than 70%.

### Example 1

Poly lactic acid copolymerized by mole ratio of (D-lactic acid)/(L-lactic acid)=1/99 having melting point of 170° C., number average molecular weight of 54000 and MFR of 50 g/10 minutes (this poly lactic acid is referred to as “PLA-1” hereinafter) was melted at 210° C., and the melt spinning was performed by extruding the melted polymer using the monocomponent structure spinning nozzle. After the extruded filament was quenched by known quenching device, the filament was drawn and made finer by an air sucker which was set under the spinning nozzle at drafting speed of 5500 m/minute. The filaments were spreaded open each other and deposited as filament web on a collecting surface of a traveling conveyor. The fineness of the single filament was 3 dtex.

The filament web was partially bonded with heat and pressure using a heated embossing roll to obtain the nonwoven fabric of filament with monocomponent structure under the condition of;

embossing pattern: point,

each bonded area: 0.6 mm²,

embossing temperature: 115° C. and

bonded area ratio: 10 percent.

Then, the nonwoven fabric was treated by dimethyl-polysiloxane aqueous emulsion to have 0.5 percent deposit thereof by weight of the nonwoven fabric, and moreover 12 percent by weight of binder, consisting of aqueous solution of poly lactic acid, was given on the whole weight of the base cloth. The base cloth for tufted carpet with weight of 100 g/m² was obtained.

On the other hand, poly lactic acid copolymerized by mole ratio of (D-lactic acid)/(L-lactic acid)=1/99 having melting point of 170° C., number average molecular weight of 69000 and MFR of 30 g/10 minutes was melted at 210° C., and the melt spinning was performed by extruding the melted polymer using the monocomponent structure spinning nozzle through the take up roll. The filament was drawn between the take up roll and a drawing roll located under the take up roll. Then, the drawn filament was passed through heated and a humidified crimping machine located under the drawing roll and was processed by treatment of relaxing and heating to obtain poly lactic acid pile yarn of 1430 dtex/64 filaments.

The poly lactic acid pile yarn obtained was tufted using a tufting machine to the base cloth of poly lactic acid for tufted carpet under the condition of gauge of 1/10, stitch of 10/2.54 cm and loop pile height of 6 mm.

On the other hand, poly lactic acid was extruded to make film, and the film obtained was laminated to the backside of the tufted base cloth as backing layer to obtain tufted carpet.

The properties of the base cloth and the carpet are shown in Table 1.

TABLE 1

| | | Example 1 | Example 2 | Example 3 | Example 4 | Example 5 | Example 6 |
|---|---|---|---|---|---|---|---|
| PLA-1 | L/D (mole ratio) | 99/1 | ← | ← | ← | ← | ← |
| | MFR (g/10 minutes) | 50 | ← | ← | ← | ← | ← |
| | Melting point (° C.) | 170 | ← | ← | ← | ← | ← |
| PLA-2 | L/D (mole ratio) | — | — | — | — | — | — |
| | MFR (g/10 minutes) | — | — | — | — | — | — |
| | Melting point (° C.) | — | — | — | — | — | — |
| Spinning | Cross-section | * | ← | ← | ← | ← | ← |
| and | Weight ratio (PLA-1/PLA2) | — | — | — | — | — | — |
| drafting | Draftimg speed (m/minute) | 5500 | ← | 5000 | 6000 | 5500 | ← |
| condition | Drafting ratio | — | — | — | — | — | — |
| | Spinnability | Good | Good | Good | Good | Good | Good |
| Filament | Fineness (dtex) | 3.3 | 6.6 | ← | ← | ← | ← |
| | Birefringence (× 10⁻³) | 17.9 | 17.5 | 16.4 | 18.6 | 17.5 | ← |
| | Crystallization degree | 18.2 | 18.3 | 17.7 | 19.2 | 18.3 | ← |
| | (percent by weight) | | | | | | |
| Treatment | Treatment method | Embossing roll | ← | ← | ← | ← | ← |
| | Temperature (° C.) | 115 | ← | ← | ← | ← | ← |
| | Binder | Poly lactic acid | ← | ← | ← | PVA** | Acrylate |
| | Needle punching | — | — | — | — | — | — |
| Primary | Weight (g/m²) | 100 | ← | ← | ← | ← | ← |
| base cloth | NSM strength (N/5 cm width) (MD/CD) | 218/156 | 207/148 | 187/133 | 227/162 | 210/150 | 210/151 |
| | Heat shrinkage (percent) (MD/CD) | 0.2/0.1 | 0.3/0.1 | 0.4/02 | 0.2/0.1 | 0.3/0.1 | 0.3/0.1 |
| | Stiffness (cN·cm/cm²) | 0.271 | 0.302 | 0.288 | 0.310 | 0.345 | 0.306 |
| Carpet | Strength retention | Good | Good | Good | Marginal | Good | Good |
| | Backing processability | Good | Good | Good | Good | Good | Good |
| | Durability against wearing out | Good | Good | Good | Good | Good | Good |
| | Biodegradability | Good | Good | Good | Good | Good | Good |

*Monocomponent round sectional configuration
**Poly vinyl alcohol

### Example 2

The extruded amount of PLA-1 from the spinning nozzle was modified to obtain filaments of single filament fineness of 6.6 dtex. Other conditions were the same as Example 1 and base cloth for tufted carpet and resulting tufted carpet were obtained.

The properties of the base cloth and the carpet are shown in Table 1.

### Example 3

The extruded amount of PLA-1 from the spinning nozzle was modified and the drawing speed by the air sucker was changed to 5000 m/minute to obtain filaments of single filament fineness of 6.6 dtex. Other conditions were the same as Example 1 and base cloth for tufted carpet and resulting tufted carpet were obtained.

The properties of the base cloth and the carpet are shown in Table 1.

### Example 4

The extruded amount of PLA-1 from the spinning nozzle was modified and the drawing speed by the air sucker was changed to 6000 m/minute to obtain filaments of single filament fineness of 6.6 dtex. Other conditions were the same as Example 1 and base cloth for tufted carpet and resulting tufted carpet were obtained.

The properties of the base cloth and the carpet are shown in Table 1.

### Example 5

Instead of the binder of aqueous solution of poly lactic acid in Example 1, binder consisting of poly vinyl alcohol aqueous solution was given to the nonwoven fabric of monocomcomponent filament in Example 1 so as to contain 12 percent by weight of the binder, and base cloth for tufted carpet was obtained. Other conditions were the same as Example 1 and base cloth for tufted carpet and resulting tufted carpet were obtained.

The properties of the base cloth and the carpet are shown in Table 1.

### Example 6

Instead of the binder of aqueous solution of poly lactic acid in Example 1, binder consisting of acrylate aqueous solution was given to the nonwoven fabric of monocomponent filament in Example 1 to contain 6 percent by weight of the binder, and base cloth for tufted carpet of weight of 100 g/m² was obtained. Other conditions were the same as Example 1 and base cloth for tufted carpet and resulting tufted carpet were obtained.

The properties of the base cloth and the carpet are shown in Table 1.

### Example 7

The following changes were made as compared with Example 1, and tufted carpet was obtained. The temperature of the embossing roll was set to 80° C. and nonwoven fabric of filament was obtained by temporary bonding with heat and pressure. Then, the obtained nonwoven fabric was passed through a needle punching machine with needle of RPD36#. The nonwoven fabric was punched by needle density of 60 punches/cm² to obtain a punched web. The punched web was then bonded by heat and pressure at temperature of 110° C. The binder containing poly lactic acid aqueous solution was given to the web to have 12 percent by weight of the binder to obtain base cloth for tufted carpet.

The properties of the base cloth thus obtained and the carpet using this base cloth are shown in Table 2.

TABLE 2

| | | Example 7 | Example 8 | Example 9 | Example 10 | Example 11 | Example 12 |
|---|---|---|---|---|---|---|---|
| PLA-1 | L/D (mole ratio) | 99/1 | ← | ← | ← | ← | ← |
| | MFR (g/10 minutes) | 50 | ← | ← | ← | ← | ← |
| | Melting point (° C.) | 170 | ← | ← | ← | ← | ← |
| PLA-2 | L/D (mole ratio) | — | 95/5 | ← | ← | 92/8** | 95/5 |
| | MFR (g/10 minutes) | — | 50 | ← | ← | ←** | 50 |
| | Melting point (° C.) | — | 150 | ← | ← | 135** | 150 |
| Spinning | Cross-section | * | Sheath-core type | ← | ← | ← | 6 lobe type |
| and drafting | Weight ratio (PLA-1/PLA2) | — | 70/30 | 50/50 | 30/70 | 50/50 | ← |
| condition | Drafting speed (m/minute) | 5500 | 5300 | ← | ← | 5200 | 5300 |
| | Drafting ratio | — | — | — | — | — | — |
| | Spinnability | Good | Good | Good | Good | Good | Good |
| Filament | Fineness (dtex) | 6.6 | ← | ← | ← | ← | ← |
| | Birefringence (× 10⁻³) | 17.5 | 17.1 | 16.9 | 16.4 | 15.5 | — |
| | Crystallization degree | 18.3 | 18.1 | 18.0 | 17.7 | 17.0 | 18.1 |
| | (percent by weight) | | | | | | |
| Treatment | Treatment method | Ebmbossing roll | ← | ← | ← | ← | ← |
| | Temperature (° C.) | 110 | 105 | ← | ← | 90 | 105 |
| | Binder | Poly lactic acid | — | — | — | — | — |
| | Needle punching | Punched | — | — | — | — | — |
| Primary | Weight (g/m²) | 100 | ← | ← | ← | ← | ← |
| base cloth | NSM strength | 226/173 | 195/145 | 191/140 | 182/133 | 180/131 | 217/164 |
| | (N/5 cm width) (MD/CD) | | | | | | |
| | Heat shrinkage (percent) (MD/CD) | 0.3/0.1 | 0.4/0.3 | 0.6/0.5 | 0.8/0.6 | 1.0/1.0 | 0.3/0.2 |
| | Stiffness (cN·cm/cm²) | 0.294 | 0.279 | 0.285 | 0.297 | 0.389 | 0.276 |
| Carpet | Strength retention | Good | Good | Good | Good | Marginal | Good |
| | Backing processability | Good | Good | Good | Good | Good | Good |
| | Durability against wearing out | Good | Good | Good | Good | Good | Good |
| | Biodegradability | Good | Good | Good | Good | Good | Good |

*Monocomponent circular round sectional configuration
**In Example 11, PLA-3 was used instead of PLA-2.

### Example 8

A nonwoven fabric using sheath-core type filament was manufactured. In detail, the sheath-core type filament, wherein PLA-1 in Example 1 was located in the core and poly lactic acid copolymerized by mole ratio of (D-lactic acid)/(L-lactic acid) =5/95 having melting point of 150° C., number average molecular weight of 51500 and MFR of 50 g/10 minutes (this poly lactic acid is referred to as “PLA-2” hereinafter) was located in the sheath, was each melt at 210° C. The melted polymers were extruded through a sheath-core type nozzle by the ratio of (PLA-1/PLA-2)=70/30 percent by weight and multicomponent filament was melt spun. After the extruded filament was quenched using a known quenching device, the filament was drawn and made finer by air sucker which was set under the spinning nozzle at drafting speed of 5300 m/minute. Filaments were spreaded open each other and deposited as a filament web on a collecting surface of a traveling conveyor. The fineness of the single filament was 6.6 dtex. The filament web was partially bonded with heat and pressure using a heated embossing roll under the condition of;

embossing pattern: point,

each bonded area: 0.6 mm²,

embossing temperature: 105° C. and

bonded area ratio: 10 percent.

Then, the filament web was treated by dimethyl-polysiloxane aqueous emulsion to have 0.5 percent deposit thereof by weight of the filament. Thus, a nonwoven fabric consisting of the sheath-core type filament with weight of 100 g/m² was obtained. This nonwoven fabric was used as base cloth for tufted carpet.

And then, the tufted carpet was obtained under the same condition as Example 1.

The properties of the base cloth and the carpet are shown in Table 2.

### Example 9

The extruded amount of PLA-1 and PLA-2 from the spinning nozzle was modified and controlled to give the ratio of (PLA-1/PLA-2) of 50/50 percent by weight. Other conditions were the same as Example 8 and base cloth and resulting tufted carpet were obtained.

The properties of the base cloth and the carpet are shown in Table 2.

### Example 10

The extruded amount of PLA-1 and PLA-2 from the spinning nozzle was modified and controlled to give the ratio of (PLA-1/PLA-2) of 30/70 percent by weight. Other conditions were the same as Example 8 and base cloth and resulting tufted carpet were obtained.

The properties of the base cloth and the carpet are shown in Table 2.

### Example 11

Compared with the polymer of Example 8, the polymer of the sheath in the sheath-core structure filament was changed. In detail a polymer was used as the sheath, which was obtained by copolymerizing by mole ratio of (D-lactic acid)/(L-lactic acid)=8/92 having melting point of 135° C., number average molecular weight of 49000 and MFR of 50 g/10 minutes (this poly lactic acid is referred to as “PLA-3” hereinafter), was melted at 210° C. The same polymer as in Example 8 was used in the core. These two polymers were extruded from the spinning nozzle with sheath-core structure. The ratio of (PLA-1/PLA-3) was adjusted to 50/50 percent by weight. The drafting speed of an air sucker was set to 5200 m/minute and the temperature of the embossing roll was 90° C. Other conditions were the same as Example 8 and base cloth and resulting tufted carpet were obtained.

The properties of the base cloth and the carpet are shown in Table 2.

### Example 12

A multilobed structure was adopted as cross-section of the filament. In detail, PLA-1 used in Example 1 and PLA-2 used in Example 8 were melted at 210° C. and extruded from the spinning nozzle to obtain the filament wherein PLA-1 was located in the core and PLA-2 was located in the 6 lobes of sheath by the ratio of (PLA-1/PLA-2) of 50/50 of weight ratio. As a result, the filament shown by FIG. 1 was spun as having a cross-section of 6-lobed sheath. After the extruded filament was quenched by a known quenching device, the filament was drawn and made finer by an air sucker which was set under the spinning nozzle at a drafting speed of 5300 m/minute. The filaments were spreaded open each other and deposited as a filament web on a collecting surface of a traveling conveyor. The fineness of the single filament constituting the web was 6.6 dtex.

In the next step, the filament web was partially bonded with heat and pressure using a heated embossing roll under the condition of;

embossing pattern: point,

each bonded area: 0.6 mm²,

embossing temperature: 105° C., and

bonded area ratio: 10 percent.

Then, the filament web was treated by dimethyl-polysiloxane emulsion to have 0.5 percent deposit thereof by weight of the filament, and a nonwoven fabric with a 6 lobe type filament with weight of 100 g/m² was obtained. This nonwoven fabric was used as base cloth. And then, tufted carpet was obtained under the same condition as Example 8.

The properties of the base cloth and the carpet are shown in Table 2.

### Example 13

PLA-1 in Example 1 and PLA-2 in Example 8 were melted at 210° C. and melt spun using a spinning nozzle for mixed filaments with mixing ratio of (PLA-1/PLA-2) of 70/30 percent by weight. After the extruded filaments were quenched using a known quenching device, the filaments were drawn and made finer by an air sucker which was set under the spinning nozzle at drafting speed of 5300 m/minute. The filaments were spreaded open each other and deposited as a filament web on a collecting surface of a traveling conveyor. The fineness of the filament consisting of PLA-1 and that of the filament consisting of PLA-2 were 6.6 dtex respectively.

The filament web was partially bonded with heat and pressure using a heated embossing roll under the condition of;

embossing pattern: point,

each bonded area: 0.6 mm²,

embossing temperature: 105° C., and

bonded area ratio: 10 percent.

Then, the filament web was treated by dimethyl-polysiloxane emulsion to have 0.5 percent deposit thereof by weight of the filament and a nonwoven fabric of the mixed filaments with weight of 100 g/m² was obtained. Tufted carpet was obtained under the same condition as Example 8.

The properties of the base cloth and the carpet are shown in Table 3.

TABLE 3

| | | | | | Comparative | Comparative | Comparative |
|---|---|---|---|---|---|---|---|
| | | Example 13 | Example 14 | Example 15 | example 1 | example 2 | example 3 |
| PLA-1 | L/D (mole ratio) | 99/1 | ← | ← | ← | ← | Polypropylene |
| | MER (g/10 minutes) | 50 | ← | ← | ← | ← | 40 |
| | Melting point (° C.) | 170 | ← | ← | ← | ← | 160 |
| PLA-2 | L/D (mole ratio) | 95/5 | ← | — | — | — | — |
| | MFR (g/10 minutes) | 50 | ← | — | — | — | — |
| | Melting point (° C.) | 150 | ← | — | — | — | — |
| Spinning | Cross-section | Mixed | Sheath-core type | Monocomponent | ← | ← | ← |
| and drawing | | | | round | | | |
| condition | Weight ratio (PLA-1/PLA2) | 70/30 | 50/50 | — | — | — | — |
| | Drafting seed m/minute | 5300 | ← | 1200 | 2300 | 7200 | 3800 |
| | Drafting ratio | — | — | 2.5 | — | — | — |
| | Spinnability | Good | Good | Good | Good | bad | Good |
| Filament | Fineness (dtex) | 6.6 | ← | ← | ← | ← | ← |
| | Birefringence (× 10⁻³) | 17.0/16.6* | 16.9 | 28.3 | 10.4 | — | — |
| | Crystallization degree | 18.2/17.3* | 18.0 | 24.7 | 12.1 | — | — |
| | (percent by weight) | | | | | | |
| Treatment | Treatment method | Embossing roll | Thermal through | Embossing roll | ← | — | Embossing roll |
| | Temperature (° C.) | 105 | 155 | 125 | 115 | — | 135 |
| | Binder | — | | Poly lactic acid | ← | — | Acrylate |
| | Needle punching | — | — | — | — | — | — |
| Primary | Weight (g/m²) | 100 | ← | ← | ← | — | 100 |
| base cloth | NSM strength | 192/136 | 148/140 | 275/196 | 93/88 | — | 247/224 |
| | (N/5 cm width) (MD/CD) | | | | | | |
| | Heat shrinkage (percent) (MD/CD) | 0.4/0.2 | 0.1/0 | 0/0 | 38/31 | — | 0.1/0 |
| | Stiffness (cN·cm/cm²) | 0.292 | 0.270 | 0.414 | 0.739 | — | 0.211 |
| Carpet | Strength retention | Good | Good | Good | Bad | — | Good |
| | Backing processability | Good | Good | Good | Bad | — | Good |
| | Durability against wearing out | Good | Good | Good | Good | — | Bad |
| | Biodegradability | Good | Good | Good | Good | — | Bad |

*In Example 13, PLA-1/PLA-2

### Example 14

The filament web obtained in Example 8 was processed by thermal through treatment using a continuous treating machine at 155° C. The treated web was then treated by dimethyl-polysiloxane aqueous emulsion to have 0.5 percent deposit thereof by weight of the filament and a nonwoven fabric of the sheath-core type filament with weight of 100 g/m² was obtained. Tufted carpet was obtained under the same condition as Example 8.

The properties of the base cloth and the carpet are shown in Table 3.

### Example 15

The base cloth for tufted carpet consisting of filaments was manufactured by spin draw take up method using PLA-1 in Example 1. In detail PLA-1 was melted at 210° C. and wasmelt spun by being extruded through a monocomponent structure spinning nozzle. After the extruded filament was quenched using a known quenching device, the filament was led to a first roll (speed of 1200 m/minute and temperature of 80° C.) located under the nozzle. The filament was drawn between the first roll and a second roll of 100° C. at a speed of 3000 m/minute, and then led to a third roll (speed of 3000 m/minute and temperature of 150° C.) to be heated at constant length. The filaments drawn at the drawing ratio of 2.5 were led to an air sucker and were spreaded open each other and deposited as a filament web on a collecting surface of a traveling conveyor. The fineness of the single filament was 6.6 dtex.

In the next step, the filament web was partially bonded with heat and pressure using a heated embossing roll under the condition of;

embossing pattern: point,

each bonded area: 0.6 mm²,

embossing temperature: 125° C., and

bonded area ratio: 10 percent.

Then, the web was treated by dimethyl-polysiloxane emulsion to have 0.5 percent deposit thereof by weight of the filament and a nonwoven fabric of the monocomponent filament with weight of 100 g/m² was obtained. Other conditions were the same as Example 1 and base cloth and resulting tufted carpet were obtained.

The properties of the base cloth and the carpet are shown in Table 3.

As is apparent in Table 1 to Table 3, the base cloth obtained in Example 1 to Example 15 had excellent mechanical stability and heat stability and also had excellent processability for carpet. Especially excellent and stable productivity was performed to manufacture the base cloth obtained in Example 8 to Example 14 consisting of the multicomponent filaments. The filaments were adhered together firmly, nevertheless the mobility of the filament in the base cloth was maintained. As a result, the strength retention after tufting was excellent. The tufted carpet obtained from these base cloth had superior biodegradability.

### Example 16

Pile yarn consisting of nylon 6 of 1430 dtex/64 filaments was tufted to the base cloth obtained in Example 8 under the condition of gauge of 1/10, stitch 10/2.54 cm and loop pile height of 6 mm using tufting machine. Then, polyethylene resin was extruded to make film. The film was laminated to the backside of the tufted base cloth to obtain tufted carpet. In this method, the strength retention was equal to or more than 80 percent. There could be observed no void and the backing layerwas uniformly attached to the base cloth.

Because the pile yarn and the backing layer were not biodegradable, when it came to disposing the carpet, the component parts (the backing layer, the pile yarn and the base cloth) could be separated. Only the base cloth with biodegradability could be biodegraded.

### Comparative Example 1

The extruded amount of PLA-1 was modified and the drawing speed of the air sucker was changed to 2300 m/minute to obtain filaments of single filament fineness of 6.6 dtex. Other conditions were the same as Example 1, and base cloth and resulting tufted carpet were obtained.

The properties of the base cloth and the carpet are shown in Table 3.

### Comparative example 2

The extruded amount of PLA-1 was modified and the drawing speed of the air sucker was changed to 7200 m/minute to obtain filaments of single filament fineness of 6.6 dtex. Other conditions were the same as Example 1 and melt spinning was attempted. However, there occurred a plurality of filament breakage and it was impossible to obtain nonwoven fabric of the filament.

The processing condition and spinnability is shown in Table 3.

### Comparative Example 3

Polypropylene with melting point of 160° C. and MFR of 40 g/10 minutes was melted at 230° C. and spun using the monocomponent structure spinning nozzle. After the extruded filament was quenched using a known quenching device, the filament was drawn and made finer by an air sucker which was set under the spinning nozzle at a drafting speed of 3800 m/minute. The filaments were spreaded open each other and deposited as a filament web on a collecting surface of a traveling conveyor. The fineness of this single filament constituting the web was 6.6 dtex. The filament web was partially bonded with heat and pressure using a heated embossing roll under the condition of;

embossing pattern: point,

each bonded area: 0.6 mm²,

embossing temperature: 105° C., and

bonded area ratio: 10 percent.

Then, the filament web was treated by dimethyl-polysiloxane emulsion to have 0.5 percent deposit thereof by weight of the filament, and a nonwoven fabric of the monocomponent filament with weight of 100 g/m² was obtained.

In the next step, the nonwoven fabric of the monocomponent filament was dipped in a binder of acrylate aqueous solution in Example 6 to obtain base cloth with 6 percent by weight of acrylate binder deposit.

On the other hand, polypropylene with melting point of 160 ° C. and MFR of 20 g/10 minutes was melted at 230° C., extruded through a monocomponent structure spinning nozzle, and spun via a take up roll. The filament was drawn between the take up roll and a drawing roll located under the take up roll. Then, the drawn filament was passed through the heated and humidified crimping machine located under the drawing roll and was processed by the treatment of relaxing and heating to obtain polypropylene pile yarn of 1430 dtex/64 filaments.

The pile yarn was tufted to the base cloth consisting of polypropylene filament. Other conditions were the same as Example 1 and tufted carpet were obtained.

The properties of the base cloth and the carpet are shown in Table 3.

As is apparent in Table 3, in comparative Example 1, the spinning speed was too low, and birefringence and crystallization degree were less than the limited minimum value of the present invention. The obtained nonwoven fabric had inferior mechanical property and heat stability. At the same time, strength retention after tufted and processability of backing were also inferior.

In comparative Example 2, spinnability at high speed spinning was poor and lots of filament breakage occurred. Therefore, base cloth for tufted carpet could not be obtained.

The tufted carpet in comparative Example 3 did not have biodegradability and as a result, the carpet had a problem when disposed. Moreover, due to cyclic compression, the pile fell down causing poor appearance.

What is claimed is:

1. Tufted carpet comprising a base cloth constitute by nonwoven fabric made of filaments formed of poly lactic acid based polymer and biodegradable pile yarn implanted by tufting method on the base cloth.

2. Tufted carpet according to claim 1, wherein the pile yarn is formed of poly lactic acid based polymer.

3. Tufted carpet according to claim 2, wherein the pile yarn is formed of bulky continuous filament.

4. Tufted carpet according to any one of claims 1 to 3, wherein backing layer is attached to a side opposite to the tufted pile side of the base cloth, and the backing layer is formed of biodegradable material.

5. Tufted carpet according to claim 1, wherein the filament has round cross-section, birefringence of 12×10⁻³ to 30×10⁻³ and crystallization degree of 15 to 25 percent by weight, and wherein the base cloth for tufted carpet has heat shrinkage of 1 percent or less at 120° C. in 3 minutes both in a machine direction and a cross direction thereto.

6. Tufted carpet according to claim 5, wherein the filament constituting the nonwoven fabric has one of the cross-sections selected from a group of single phase, side-by-side, islands-sea and sheath-core types.

7. Tufted carpet according to claim 1, wherein the filament has non-round cross-section and crystallization degree of 15 to 25 percent by weight, and wherein the base cloth for tufted carpet has heat shrinkage of 1 percent or less at 120° C. in 3 minutes both in a machine direction and a cross direction thereto.

8. Tufted carpet according to claim 7, wherein the filament constituting the nonwoven fabric has one of the cross-sections selected from a group of single phase, side-by-side, islands-sea, sheath-core and multilobe types.

9. Tufted carpet according to any one of claims 1 to 3 and 5 to 8, wherein the filaments constituting the nonwoven fabric are thermally bonded with each other.

10. Tufted carpet according to claim 9, wherein the filaments constituting the nonwoven fabric are partially bonded with heat and pressure with each other or thermally bonded at contact points of the filaments.

11. Tufted carpet according to claim 10, wherein the filaments are adhered with each other by binder resin at the contact points thereof.

12. Tufted carpet according to claim 11, wherein the binder resin is poly lactic acid based polymer.

13. Tufted carpet according to claim 9, wherein the filaments constituting the nonwoven fabric are entangled and partially bonded with heat and pressure with each other or entangled and thermally bonded at contact points of the filaments.

14. Tufted carpet according to claim 13, wherein the filaments are adhered with each other by binder resin at the contact points thereof.

15. Tufted carpet according to claim 14, wherein the binder resin is poly lactic acid based polymer.
